(19) United States
(12) Patent Application Publication
(10) Pub. No.: US 2010/0173577 A1
(43) Pub. Date: Jul. 8, 2010

(54) BLOWER FOR A MOTOR VEHICLE

(75) Inventors: Stefan Lummitsch, Limburg (DE); Dirk Matthias Wexel, Mainz (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/663,677

(22) PCT Filed: Apr. 12, 2008
(86) PCT No.: PCT/EP08/02916

§ 371 Date: Dec. 8, 2009

(30) Foreign Application Priority Data
Jun. 8, 2007 (DE) 102007026611.3

(51) Int. Cl. B60H 1/26; F04D 29/40; F24F 7/007

(52) U.S. Cl. 454/143; 415/214.1; 454/338

(57) ABSTRACT

A blower is provided for the fresh air supply into the interior of a motor vehicle, with a housing of at least two housing parts, which via their housing splits can be sealed to the outside. The first housing part is assigned a first air suction or air outlet opening and the second housing part a second air suction or air blow-out opening. The housing splits allow a sealing connection of the two housing parts in a first relative position (A) and in at least a further relative position (B, C) to one another, with fastening means for connecting the two housing parts in the first relative position (A) of the housing split and with additional fastening means for their connecting in the further relative position (B, C). The additional fastening means upon a connection in the first relative position remains unutilized.

### CROSS-REFERENCE TO RELATED APPLICATIONS

This application is a U.S. National-Stage entry under 35 U.S.C. §371 based on International Application No. PCT/EP2008/002916, filed Apr. 12, 2008, which was published under PCT Article 21(2) and which claims priority to German Application No. 102007026611.3, filed Jun. 8, 2007, which are all hereby incorporated in their entirety by reference.

### TECHNICAL FIELD

The invention relates to a blower for a motor vehicle, which with regard to the arrangement of its suction and blow-out hoses can be handled flexibly.

### BACKGROUND

A blower comprises a suction or inlet opening and a blow-out or outlet opening each of which is to be connected with the hose to additional components. In confined space conditions, such as are present more preferably with a motor vehicle, it is sometimes difficult to connect the hoses with the blower. An example of the above-mentioned connecting problems is the installation of a blower in the longitudinal centre console arranged in vehicle longitudinal direction and in the middle of the vehicle, since this is to serve as a tray as well and to that extent is partially utilized as such.

With a motor vehicle that is manufactured by a corporation operating throughout the world with a wide range of vehicle models it is added that in the endeavor of using as many identical parts as possible, the fewest possible and preferably only a single blower model is to be used. This restricts the possibilities of better managing the limited space available by selecting another blower model and solving the above-mentioned connection problem for the hoses in this manner. The problem is further aggravated in that the blower as an identical part is to be used in as many vehicle models as possible, which among other things are characterized by a different vehicle width and length. Under the mentioned conditions, only one blower model should therefore be useable in as many vehicle models as possible under highly confined space conditions.

It is an object of an embodiment of the invention to make available a blower to which hoses can be favorably connected to the intake and outlet openings even under confined space conditions.

Additional objects relate to the provision of a blower arrangement and an air-conditioning system for a motor vehicle with such a blower and the provision of a motor vehicle equipped with this. In addition, other objects, desirable features, and characteristics will become apparent from the subsequent summary and detailed description, and the appended claims, taken in conjunction with the accompanying drawings and this background.

### SUMMARY

A first embodiment of the invention relates to a blower for the fresh air supply into the interior of a motor vehicle. The blower comprises a blower motor and a corresponding housing. The housing comprises at least two housing parts via the housing splits of which the housing can be sealed towards the outside. The first housing part comprises a first suction or outlet opening and the second housing part comprises a second suction or outlet opening. The housing splits allow a sealing connection of the two housing parts in a first relative position and in at least one additional relative position to each other. The blower comprises fastening means for the connecting of the two housing parts in the first relative position of the housing split. Furthermore, the blower comprises additional fastening means for the connecting of the housing splits in the further relative position. The additional fastening means remain unutilized upon connection in the first relative position.

Because of the additional fastening means the housing can be employed more flexibly. By way of the additional fastening means the position of the suction or outlet opening of the first housing part can be adjusted or varied relative to the position of the suction or outlet opening of the second housing part, as a result of which more degrees of freedom are obtained when connecting the hoses. If for example position of the suction opening is predetermined, the position of the blow-out opening can be adjusted with the mentioned embodiment. Conversely, the position of the suction opening can be varied if the position of the blow-out opening is predetermined.

With this choice adapted to the respective conditions in the vehicle, with identical position of the blower, the hoses fastened to the openings can also protrude in another direction, wherein other components are no longer in the way of the hoses. Thus, additional connection possibilities are obtained through the additional fastening means.

In a second embodiment the relative positions with the housing splits are determined via engagements. As a result it is possible on the one hand to select different relative orientations of the housing parts but the orientation then selected is fixed and cannot change through shaking movements of the vehicle. An example of this is radial housing splits with engagements, which prevent twisting of the housing parts relative to each other.

In a further embodiment surplus screw domes are provided as additional fastening means.

Surplus here means that the mentioned screw domes are not used in the first relative position of the housing splits but only in the at least one further relative position. With a radial housing split for example with four existing screw domes A, B, C and D the screw domes A, B and C can be used for the first relative position whereas the screw dome D remains unutilized. In the second relative position for example the screw domes B, C and D are used, while the screw dome A remains unutilized. The use of different screw domes then brings about another position of the sockets for the air supply or discharge with well defined position of the at least two housing parts relative to each other, which is even more reliable than engagement. It is to be understood that other types of fastening can also be used, for example clamping and the like.

In a further embodiment the blower is embodied as a blower to be arranged in the bulkhead region of a motor vehicle, by means of which fresh air, which can be heated if applicable, is centrally supplied to the vehicle interior. Alternatively the blower is the motor vehicle climate module with which fresh air is supplied to the vehicle interior, which air can be heated or cooled as applicable. As climate module it is a usual part of the motor vehicle air conditioning system. Because of the additional connection possibilities which are obtained through the additional fastening means, these components can also be more easily employed in various vehicle models.

A second embodiment of the invention relates to a blower arrangement for the installation in or installed in the centre console of a motor vehicle. This comprises a blower according to one of the embodiments described above, wherein the blower comprises an air suction tract and an air blow-out tract. The air suction tract can be connected to a further blower of the motor vehicle or its climate module or is connected thereto. The air blow-out tract is connected with an air outlet opening assigned to the second or third seat row.

With this blower arrangement the use of one and the same (additional) blower in differently dimensioned centre consoles in different vehicle models for example compact vehicle or VAN becomes possible. With a center console, upon installation of the hoses, the trays integrated in the centre console, the respective length of the centre console and the height of the air outlet opening relative to the floor surface have to be taken into account. These parameters differ depending on vehicle model. The proposed blower arrangement offers additional possibilities of more easily satisfying these parameters for different vehicle models under the confined conditions in the center console. Furthermore, holders for assembling the blower arrangement within the center console are more easily omitted.

Further features and advantages of the claimed invention become evident from the description detailed in the following with respect to the enclosed drawings, which are stated in the following as non-restricting examples.

### BRIEF DESCRIPTION OF THE DRAWINGS

The present invention will hereinafter be described in conjunction with the following drawing figures, wherein like numerals denote like elements, and:

FIG. 1 a perspective lateral view of a blower arrangement for a centre console of a passenger car;

FIG. 2 a detail view of FIG. 1;

FIG. 3 a schematic lateral view of three relative positions A, B, and C;

FIG. 4 a housing, whose housing splits comprise engagements; and

FIG. 5 a main climate module.

### DETAILED DESCRIPTION

The following detailed description is merely exemplary in nature and is not intended to limit application and uses. Furthermore, there is no intention to be bound by any theory presented in the preceding background or summary or the following detailed description.

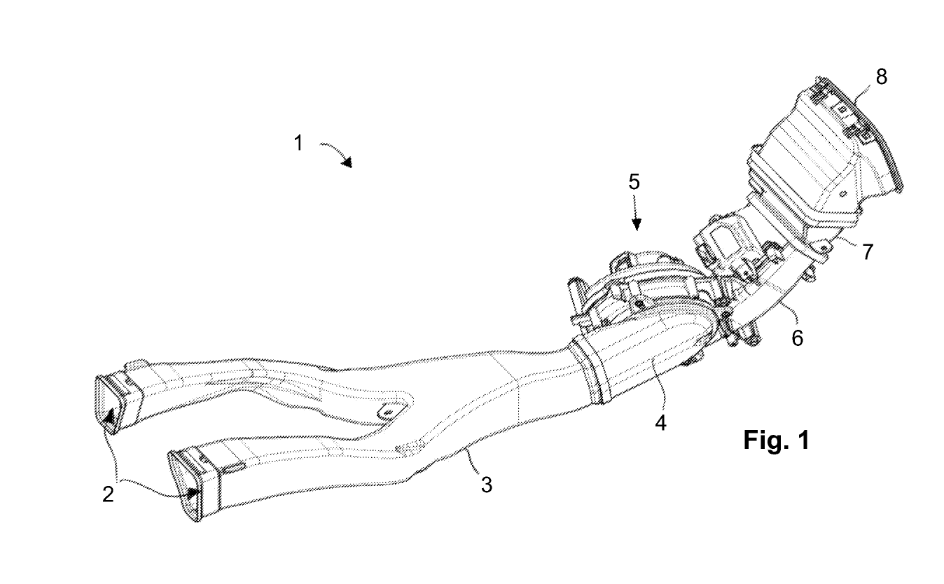

With the figures, which generally designate same items with same reference characters, FIG. 1 shows a blower arrangement 1 for a centre console of a passenger car. The blower arrangement 1 comprises two air suction openings 2, which can be connected to the blower or to the climate module (not shown). The air suction openings 2 via a forking air conducting hose 3 lead to the suction tract 4 of the blower 5. From the blow-out tract 6 the air via an air conducting hose 7 then reaches the air outlet opening 8, which can be assigned to the second or third seat row.

It is evident that the air conducting hoses 3 and 7 are arranged at an angle to each other. This angle is dependent on the respective vehicle model so that in the state of the art, depending on the vehicle model, different blowers are used in order to take into account the space conditions in the respective centre console.

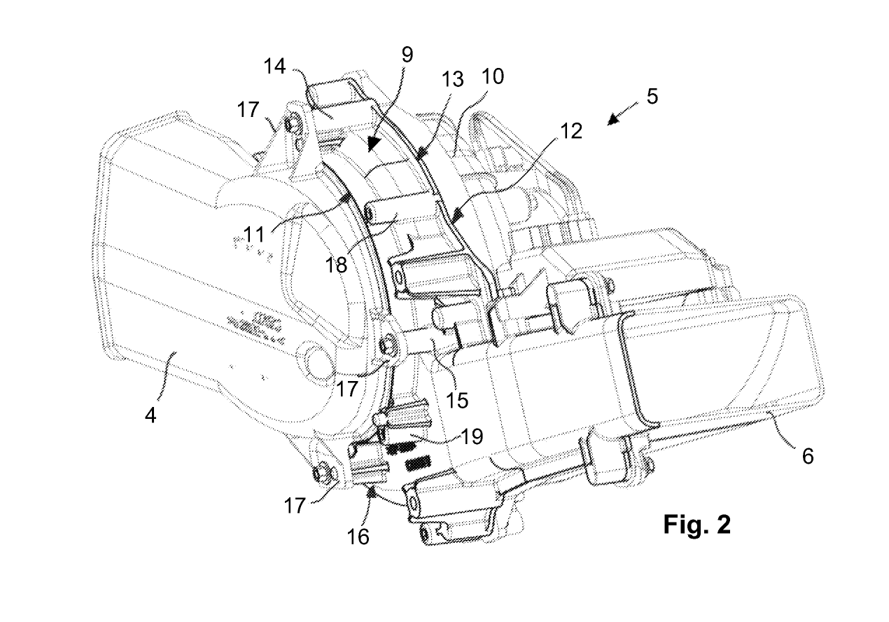

FIG. 2 shows a detail view of FIG. 1. The blower 5 has three housing parts, namely the housing parts 9 and 10, as well as the suction tract 4. The housing parts 9 and 10 each have circular housing splits 11, 12 and 13.

In the configuration shown in FIG. 2 the two housing parts 4 and 9 are screwed together, specifically with three screw domes 14, 15 and 16, each of which is assigned a holding eye 17 of the suction tract 4. Furthermore, the middle housing part 9 comprises surplus screw domes 18 and 19 which are not utilized in the shown configuration, since they are not assigned any holding eyes. With the surplus screw domes 18 and 19, the position of the suction tract 4 is changed relative to the position of the blow-out tract 6.

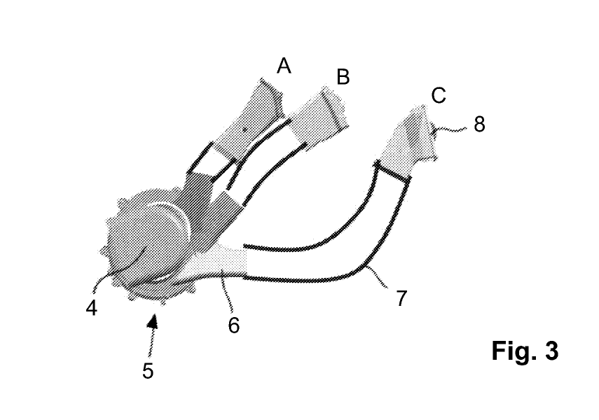

Through utilization of the surplus screw domes 18, 19 two further configurations are obtained for the blower arrangement 1. The blow-out region, which comprises the blow-out tract 6, the air conducting hose 7 as well as the blow-out opening 8 of the altogether 3 configurations is schematically shown in FIG. 3. The three configurations each define relative positions A, B, C of the housing splits to one another. The three relative positions facilitate the utilization of a single blower 5 with different vehicle models in that the adaptation to the vehicle model is not performed through the selection of a further blower model, but through a selection of the existing screw domes. Furthermore, the design of holders for the blower arrangement 1 within the centre console is simplified.

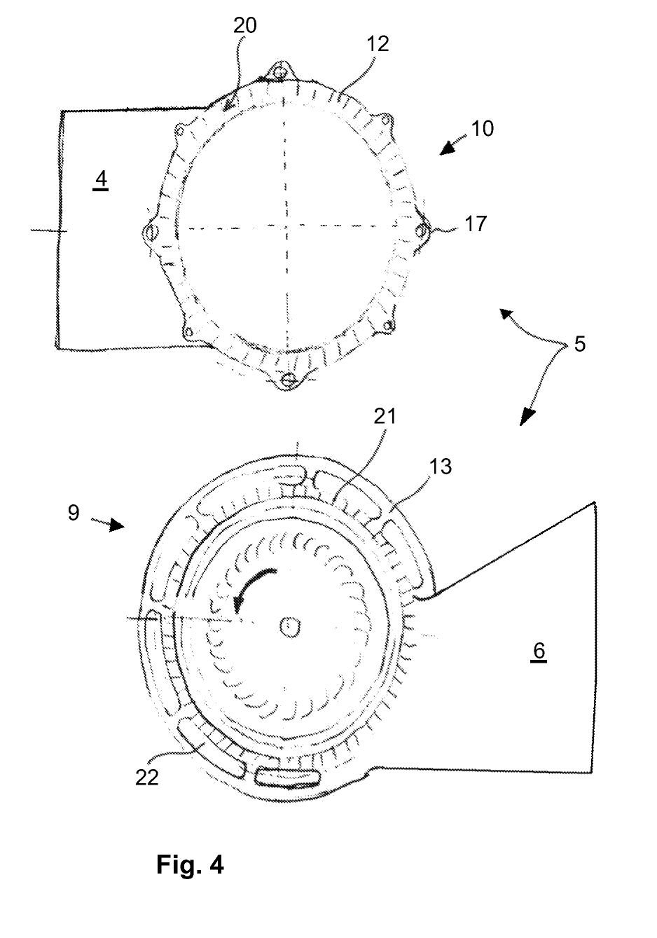

FIG. 4 shows a further embodiment of a housing 5 with a view onto its housing part 9 having a radial housing split 13 and whose second housing part 10, which likewise has a radial housing split 12. The housing splits 12 and 13 are secured against rotation via an engagement, specifically through elevations 20, which engage in corresponding depressions 21 of the housing split 13, which defines their position relative to each other. The engagement position is fixed through a screw (not shown), which is guided through the holding eyes 17 and the elongated holes 22. This example makes it clear that other types of fastening means can also be used in order to join the two housing parts 9 and 10, while for example engagements fix the relative position.

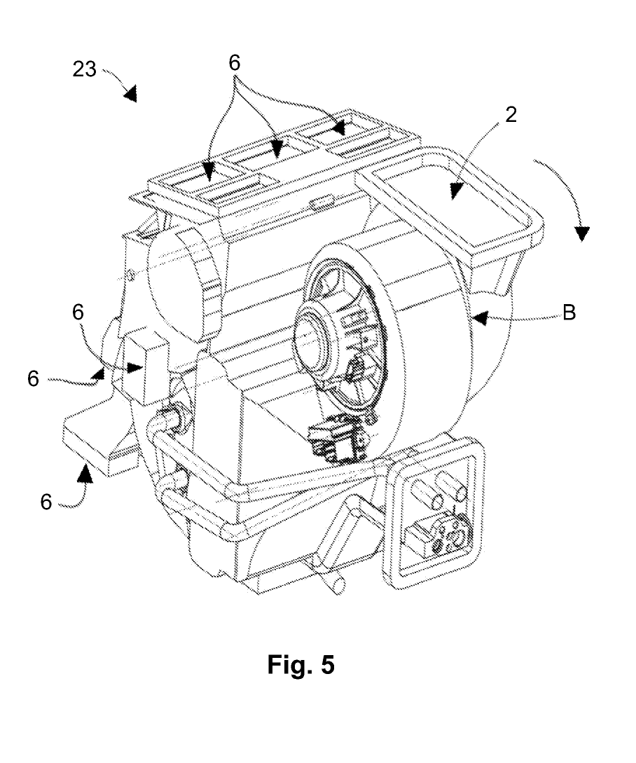

FIG. 5 shows a climate module 23 of a motor vehicle air-conditioning system, which comprises a central air suction opening 2 and a plurality of air outlet openings 6. The housing splits in the region B, which can be connected in one of the manners described above, can be utilized in order to swivel the air suction opening 2 in the direction of the arrow. By swiveling the air suction opening 2 it is more easily possible to employ the climate module 23 in as many vehicle models as possible.

In addition, the installation of the climate module 23 in the vehicle is facilitated. Although concrete embodiments are described above, it will be clear to the person skilled in the art that the description of these embodiments does not serve to restrict the invention in the form stated. On the contrary, the invention is to comprise all modifications, equivalents and alternatives which fall in the scope of protection of the claimed invention.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A blower for a fresh air supply into an interior of a motor vehicle, comprising:
a housing comprising a first housing part and a second housing part that, the first housing part can be sealed to an outside via a first housing split and the second housing part can be sealed to the outside via a second housing split;
a first air opening assigned to the first housing part;
a second air opening assigned to the second housing part, wherein the first housing split and the second housing split allow a sealing connection of the first housing part and the second housing part in a first relative position and in at least one additional relative position to each other; and
a fastener adapted to connect the first housing part and the second housing part in the first relative position and with an additional fastener adapted to connect in the at least one additional relative position, wherein the additional fastener with a connection in the first relative position remaining unutilized.

2. The blower according to claim 1, wherein the first relative position and the at least one additional relative position are fixed via engagements.

3. The blower according to claim 1, further comprising a surplus screw dome as the additional fastener.

4. A blower that is positionable in a bulkhead region of a motor vehicle for a fresh air supply into a vehicle interior, comprising:
a housing comprising a first housing part and a second housing part that, the first housing part can be sealed to an outside via a first housing split and the second housing part can be sealed to the outside via a second housing split;
a first air opening assigned to the first housing part;
a second air opening assigned to the second housing part, wherein the first housing split and the second housing split allow a sealing connection of the first housing art and the second housing part in a first relative position and in at least one additional relative position to each other; and
a fastener adapted to connect the first housing part and the second housing part in the first relative position and with an additional fastener adapted to connect in the at least one additional relative position, wherein the additional fastener with a connection in the first relative position remaining unutilized.

5. A blower arrangement for installation in a centre console of a motor vehicle, comprising:
a blower, comprising:
a housing comprising a first housing part and a second housing part that, the first housing part can be sealed to an outside via a first housing split and the second housing part can be sealed to the outside via a second housing split;
a first air opening assigned to the first housing part;
a second air opening assigned to the second housing part, wherein the first housing split and the second housing split allow a sealing connection of the first housing part and the second housing part in a first relative position and in at least one additional relative position to each other;
a fastener adapted to connect the first housing part and the second housing part in the first relative position and with an additional fastener adapted to connect in the at least one additional relative position, wherein the additional fastener with a connection in the first relative position remaining unutilized;
an air suction tract adapted for connection to a further blower of the motor vehicle; and
an air blow-out tract adapted for connection with an air outlet opening assigned to a seat row greater then one.

6-7. (canceled)

8. The blower according to claim 4, wherein the first relative position and the at least one additional relative position are fixed via engagements.

9. The blower according to claim 4, further comprising a surplus screw dome as the additional fastener.

10. The blower according to claim 5, wherein the first relative position and the at least one additional relative position are fixed via engagements.

11. The blower according to claim 5, further comprising a surplus screw dome as the additional fastener.
